(19) United States
(12) Patent Application Publication
(10) Pub. No.: US 2025/0228388 A1
(43) Pub. Date: Jul. 17, 2025

(54) POWDER HOLDER FOR A DRINKS PREPARATION DEVICE

(71) Applicant: EUGSTER / FRISMAG AG, Amriswil (CH)

(72) Inventors: Wolfgang Riessbeck, Landschlacht (CH); Hendrik Van De Löcht, Riedt bei Erlen (CH); Thomas Brüntrup, Siblingen (CH)

(73) Assignee: EUGSTER / FRISMAG AG, Amriswil (CH)

(21) Appl. No.: 18/854,354

(22) PCT Filed: Aug. 24, 2022
(86) PCT No.: PCT/EP2022/073545

§ 371 Date: Oct. 4, 2024

(30) Foreign Application Priority Data
Apr. 6, 2022 (DE) 10 2022 108 253.9

(51) Int. Cl. A47J 31/06; A47J 31/34; A47J 31/44

(52) U.S. Cl. CPC A47J 31/0647; A47J 31/34; A47J 31/4403

(57) ABSTRACT

The invention relates to a powder container (1) that can be removably received in a drinks preparation device, wherein the powder holder (1) comprises a housing element (2), a brewing chamber wall (3), a guide element (5) and a brewing chamber base (4) mounted such that it can move in an axial direction, wherein the brewing chamber base (4) is designed to sealingly contact the brewing chamber wall (3) and has filter means for retaining a drinks substrate during a brewing process. According to the invention, the guide element (5) is in the form of a torque conversion sleeve and a first guide (10) is arranged on the guide element (5), wherein the brewing chamber base (4) and the brewing chamber wall (3) are guided in the first guide, and wherein the guide element (5) and the first guide (10) are configured such that a rotation of the housing element (2) relative to the brewing chamber wall (3) brings about an axial adjustment (8) of the guide element (5) relative to the brewing chamber wall (3) and an axial adjustment (8) of the brewing chamber base (4) relative to the guide element (5), such that a two-stage, additive axial adjustment (8) of the brewing chamber base (4) relative to the brewing chamber wall (3) between an uppermost and a lowermost position takes place.

### BACKGROUND OF THE INVENTION

The invention relates to a powder holder to be removably received in a beverage preparation device and a beverage preparation device with a powder holder.

Powder holders for beverage preparation devices that brew beverages by arranging a beverage substrate, for example coffee powder, on a filter or a bottom of the powder holder and connecting it to a brewing head of the beverage preparation device, thus forming a brewing chamber, and sealing it are known in the prior art. The beverage is prepared by the beverage preparation device passing or pressing brewing fluid, preferably hot water, through the powder holder. In order to facilitate cleaning of the powder holder and removal of the used coffee powder, the powder holder can be removed from the coffee maker.

The application DE 10 2021 133 074 A1 discloses beverage powder holders that allow the bottom of the brewing chamber to be raised to or above the edge of the wall of the brewing chamber after removal so that the used coffee powder can be easily and quickly removed from the brewing chamber. This is made possible by a guide rail, which, at the bottom end, is integrally connected to the wall of the brewing chamber forming the brewing chamber. The bottom of the brewing chamber is supported by a point contact and forcibly guided with little friction. A disadvantage of this design, though, is that it requires additional space for displacement at the bottom end and that the powder holder is therefore very large.

Further, a powder holder that achieves height adjustment of the bottom of the filter through displacement of two wave-shaped edges facing each other in order to halve the brewing chamber volume at will is disclosed in the application EP 2 087 818 A1. Due to the wave shape, the edges interlock in a space-saving manner when the bottom of the brewing chamber is in the bottom position. Further provided is a second guide edge that is also wave-shaped and at which the bottom of the brewing chamber can be raised further past the edge of the brewing chamber from the halfway position to facilitate removal of coffee grounds. The gradual raising of the bottom of the brewing chamber by means of the second guides reduces the height of displacement. The reduction results from the fact that the minimum height of displacement is specified by the edge height of the individual guides, with the edge height reduced by half due to the two-stage embodiment with two guides. An axial restoring force is applied to the edges by a spring so that the edges remain in contact when rotating in opposite directions. However, friction occurs due to the flat contact between the edges and the additional force applied by the spring, whereby rotation of the powder holder is made more difficult.

A removable brewing unit that is adjustably driven along a longitudinal axis is disclosed in the utility model DE 20 2009 000 075 U1. It is driven by means of a lead screw received in a threaded sleeve that is fixedly secured to the brewing unit. Adjustment is stabilized by at least one additional guide.

Further, the utility model DE 20 2004 018 223 U1 discloses a brewing device for pod coffee makers, wherein the brewing device comprises an upper part and a lower part. The upper part is fixedly secured such that it is vertically adjustable in relation to the lower part by means of a guide and forms a brewing chamber therewith. The upper part also has helically designed guide webs extending in the circumferential and axial directions, which convert a rotational motion of an actuation part in the circumferential direction into the vertical adjustment of the upper part in relation to the lower part. The lower part comprises a cassette that can be removed in the radial direction and which receives the coffee pod and forms the lower part of the brewing chamber.

### SUMMARY OF THE INVENTION

Therefore, there is a great need for a powder holder that allows and facilitates the removal of a beverage substrate and at the same time is both space-saving and easy to move. Nevertheless, handling the powder holder should be as simple and intuitive as possible. The object of the invention is to provide such a powder holder and at the same time overcome the disadvantages found in the prior art.

This object is attained in a surprisingly simple but effective way by a powder holder according to the teaching disclosed herein.

According to the invention, there is proposed a powder holder to be removably received in a beverage preparation device, in particular a coffee or espresso maker, wherein the powder holder comprises a housing element, a wall of the brewing chamber, a guide element and a bottom of the brewing chamber movably mounted in an axial direction, wherein the bottom of the brewing chamber is in sealing contact with the wall of the brewing chamber and is formed with filter means for retaining a beverage substrate, in particular coffee powder, during a brewing process.

The powder holder is characterized in that the guide element is formed as conversion sleeve and a first guide is arranged on the guide element, wherein the bottom of the brewing chamber and the wall of the brewing chamber are guided in the first guide and wherein the guide element and the first guide are designed such that a rotation of the housing element in relation to the wall of the brewing chamber causes an axial adjustment of the guide element in relation to the wall of the brewing chamber and an axial adjustment of the bottom of the brewing chamber in relation to the guide element, so that a two-stage, additive axial adjustment of the bottom of the brewing chamber in relation to the wall of the brewing chamber takes place between a top position and a bottom position.

The powder holder is used to hold a beverage substrate through which hot brewing fluid, preferably hot water, is passed or pressed under pressure during a brewing process. The hot brewing fluid absorbs substances, in particular flavoring, from the beverage substrate during the brewing process, and a flavored beverage results from the brewing fluid in the process. The powder holder comprises a brewing chamber, which is formed by the wall of the brewing chamber and the bottom of the brewing chamber so that the powder holder can hold the beverage substrate and the fluid during the brewing process. For this purpose, the wall of the brewing chamber is closed in the circumferential direction and open at both ends in the axial direction. The wall of the brewing chamber can preferably be designed by extrusion along a normal of a surface with a recess. The design of the surface and the recess is basically arbitrary, with the surface with the recess preferably being a circular ring and the wall of the brewing chamber therefore preferably being a hollow cylinder. The hot brewing fluid is introduced into the brewing chamber through the upper opening of the wall of the brewing chamber before and/or during the brewing process. This is generally accomplished by a brewing head of the beverage preparation device, to which the powder holder is removably attached, preferably by a bayonet locking means, to carry out a brewing operation or brewing process. The outer edge of the bottom of the brewing chamber is designed according to the shape of the recess, thereby allowing the bottom of the brewing chamber to come into sealing contact with the wall of the brewing chamber. In other words, the outer edge of the bottom of the brewing chamber replicates the design of the inside of the wall of the brewing chamber. The bottom of the brewing chamber is therefore preferably formed as a disk. The wall of the brewing chamber and the bottom of the brewing chamber together form the brewing chamber. The bottom of the brewing chamber comprises the filter means on which the beverage substrate is placed within the brewing chamber. The filter means are designed in such a way that the hot brewing fluid can leave the brewing chamber through the filter means as an automated beverage after it has passed through the beverage substrate in the brewing chamber during the brewing process. In this process, the filter means retain the beverage substrate.

The bottom of the brewing chamber is movably mounted in the axial direction so that the beverage substrate can be easily removed after the brewing process. The adjustability is limited in both axial directions, with the limitation defining a top position and a bottom position. If the bottom of the brewing chamber is in the bottom position, the brewing chamber has a maximum volume. This bottom position of the bottom of the brewing chamber is referred to as the “brewing position”, since this position should be assumed during the brewing process. If the bottom of the brewing chamber is in the top position in the axial direction, the bottom of the brewing chamber is in the “ejection position”. In this position, used beverage substrate at the bottom of the brewing chamber can advantageously be raised above the upper edge of the wall of the brewing chamber and thus easily removed. Adjustment in the axial direction is preferably limited by the dimensions of the wall of the brewing chamber. In other words, when the bottom of the brewing chamber is in the ejection position, the bottom of the brewing chamber is flush with the upper edge of the wall of the brewing chamber and when the bottom of the brewing chamber is in the brewing position, the bottom of the brewing chamber is flush with the lower edge of the wall of the brewing chamber. Even more preferably, the bottom of the brewing chamber is spaced upwardly from the lower edge of the wall of the brewing chamber and there is in sealing contact with the wall of the brewing chamber when the bottom of the brewing chamber is in the brewing position. As a result, the bottom of the brewing chamber is stabilized in its position and possible production-related deviations are compensated. It is also preferably conceivable that the bottom of the brewing chamber be spaced from the upper edge of the wall of the brewing chamber in the ejection position and be arranged above the brewing chamber in order to be flush with a conceivable cover element.

The powder holder has a guide element to allow axial adjustability of the bottom of the brewing chamber. A first guide is arranged at the guide element. The guide element is designed to be axially adjustable, both in relation to the wall of the brewing chamber and in relation to the bottom of the brewing chamber. Both the axial adjustment of the guide element in relation to the wall of the brewing chamber and the axial adjustment of the bottom of the brewing chamber in relation to the guide element are caused by a rotation of the housing element in relation to the wall of the brewing chamber and the bottom of the brewing chamber. The two axial adjustments always run in the same direction in relation to the wall of the brewing chamber, in other words, either upwards or downwards, so that an additive axial adjustment results for the bottom of the brewing chamber in relation to the wall of the brewing chamber. In other words, the guide element moves upwards or downwards in relation to the wall of the brewing chamber when the housing element rotates in the axial direction with the bottom of the brewing chamber and the bottom of the brewing chamber also moves upwards or downwards in the axial direction in relation to the guide element at the same time so that the bottom of the brewing chamber undergoes both axial adjustments in relation to the wall of the brewing chamber. To make this possible, both the bottom of the brewing chamber and the wall of the brewing chamber are guided in the first guide and the guide element is formed as a conversion sleeve. The axial adjustments always take place simultaneously to allow particularly fast and smooth adjustment of the bottom of the brewing chamber in relation to the wall of the brewing chamber. Having the wall of the brewing chamber and the bottom of the brewing chamber guided in the same guide further makes it possible to develop them in a wraparound manner. This means that the axial adjustment of the guide element in relation to the wall of the brewing chamber and the axial adjustment of the bottom of the brewing chamber in relation to the guide element forcibly result in both axial directions. Therefore, there is no need to apply additional force, for example by a spring, thereby significantly reducing the friction caused by displacement in the first guide and making the powder holder easy to move. This effect is further enhanced by the fact that a flat contact is no longer needed and that it is preferably designed as a point due to the wraparound forced guidance in both directions.

The design of the guide element as a sleeve allows the flavored beverages to flow out of the brewing chamber due to the hollow design. A sleeve is understood to be a hollow cylinder. The outer radius of the guide element is preferably smaller than the inner radius of the wall of the brewing chamber and the diameter of the bottom of the brewing chamber. In this way, the guide element can be at least partially received in the interior of the wall of the brewing chamber when the bottom of the brewing chamber is in the top position, thereby transmitting the axial movement to the bottom of the brewing chamber.

The housing element at least partially encloses the bottom of the brewing chamber, the conversion sleeve and the wall of the brewing chamber in the radial direction and is movably designed in the circumferential direction in relation to the bottom of the brewing chamber and/or the wall of the brewing chamber to allow rotation.

The removable reception of the filter holder is made possible by the fact that the powder holder can be removed from the beverage preparation device. Removable means that the powder holder is technically designed to allow the filter carrier to be spatially separated from the beverage preparation device without destroying it. In particular, it is possible to spatially separate the powder holder from the beverage preparation device without the aid of tools. The removable powder holder can be designed as a suspension element on the powder holder, wherein the suspension element can be inserted into a suitable rail of the beverage preparation device. The removable reception makes it possible to remove the powder holder from the beverage preparation device after the brewing process, directly dispose of the used beverage substrate and quickly and easily clean the powder holder. Another advantage is that elaborate cleaning of the entire beverage preparation device to eliminate contamination by used beverage substrate collected in the beverage preparation device is unnecessary.

Basically any beverage substrate can be used in the powder holder, with the beverage substrate, coffee powder, preferred.

The basic idea of the invention is that the two-stage, additive axial adjustment of the bottom of the brewing chamber in relation to the wall of the brewing chamber allows the housing element to be made more compact overall. This is achieved by the fact that the guide element, the wall of the brewing chamber and the bottom of the brewing chamber can be pushed together and pulled apart in the manner of a telescopic rod. The simultaneous guidance of the bottom of the brewing chamber and the wall of the brewing chamber in a common first guide allows rotational forced guidance in both axial directions, thus ultimately reducing friction and leading to smooth adjustment.

The invention makes it possible to provide a powder holder that is easy and intuitive to use and allows quick and easy removal of beverage substrate from the brewing chamber. The powder holder has a compact and space-saving design.

Advantageous further designs of the invention, which can be realized individually or in combination, are shown in the subclaims.

In a further design of the powder holder, it is advantageous that the first guide is formed by a first guide track that is preferably crown-shaped and closed in the circumferential direction, with alternately arranged first flanks inclined in the axial direction, to allow simultaneous displacement of the guide element and the bottom of the brewing chamber and of the guide element and the wall of the brewing chamber in the axial direction and in the circumferential direction; that a second guide is formed between the housing element and the guide element, wherein the second guide is formed to allow displacement of the housing element and the guide element in the axial direction; that a third guide is formed between the bottom of the brewing chamber and the wall of the brewing chamber, wherein the third guide is formed to allow displacement of the wall of the brewing chamber and bottom of the brewing chamber or displacement of the guide element and the bottom of the brewing chamber in the axial direction; and/or that a fourth guide is formed between the housing element and the wall of the brewing chamber, wherein the fourth guide is formed to allow the rotation of the housing element, in particular the rotation between the housing element and wall of the brewing chamber, in the circumferential direction.

The preferred design of the first guide makes additive axial adjustment especially easy to perform by the bottom of the brewing chamber sliding up or down one or more first flanks and the wall of the brewing chamber simultaneously sliding down or up one or more other first flanks. This is made possible by rotation of the guide element in relation to the wall of the brewing chamber and the bottom of the brewing chamber. In other words, the inclined first flanks convert the rotational motion of the guide element into opposing axial adjustments of the wall of the brewing chamber and the bottom of the brewing chamber at the first flanks inclined in the axial direction, which are enclosed by the first guide. The first flanks are inclined in the axial direction by having the individual first flank basically oriented in the circumferential direction and the orientation subsequently rotated in the axial direction in the design. In other words, the first flanks follow a section of a helix shape in space. The greater the torsion of the first flanks in the axial direction, the steeper the first flanks are designed. For ease of use, the first guide preferably makes it possible to the convert the rotational motion of the guide element into the opposing axial adjustments of the bottom of the brewing chamber and the wall of the brewing chamber regardless of the direction of rotation. Therefore, a first flank that is twisted in one direction is followed by a first flank that is twisted in the opposite direction, resulting in an alternating, crown-shaped arrangement of the first flanks. The first guide is preferably arranged on the outside of the guide element. The first guide is designed such that it is closed in the circumferential direction to allow the user to rotate the powder holder comfortably and continuously without limitation.

The preferred design of the second guide ensures that the guide element in the housing element can only be adjusted in the axial direction. This means that any rotation of the housing element is also transmitted to the guide element. As a result, the axial adjustment of the guide element in relation to the wall of the brewing chamber in accordance with the invention is also possible when the wall of the brewing chamber and the housing element are fixedly secured in the axial direction in relation to each other. The axial fixation of the housing element and the wall of the brewing chamber ensures that none of the guides can be touched by the user of the powder holder in the case of a closed design of the inside of the wall of the brewing chamber and the outside of the housing element in combination with the bottom of the brewing chamber, which is in sealing contact with the wall of the brewing chamber. This not only protects the user from pinching, but also the guides themselves from damage by the user or contamination, thereby contributing to improved durability.

The preferred design of the third guide ensures that the bottom of the brewing chamber and the wall of the brewing chamber are fixed in the circumferential direction in relation to each other. This improves the seal and reduces the friction between the bottom of the brewing chamber and the wall of the brewing chamber when the bottom of the brewing chamber is in sealing contact with the wall of the brewing chamber in accordance with the invention, because the relative movements of the wall of the brewing chamber and the bottom of the brewing chamber in relation to each other is limited to the axial adjustment in relation to each other in accordance with the invention. In other words, with the exception of the axial adjustment according to the invention, the third guide prevents all other relative movements of the bottom of the brewing chamber and the wall of the brewing chamber, which are thus not required for the inventive idea. A good seal between the bottom of the brewing chamber and the wall of the brewing chamber protects the interior from contamination, and low friction between the bottom of the brewing chamber and the wall of the brewing chamber allows smooth adjustment of the bottom of the brewing chamber and the wall of the brewing chamber in relation to each other.

The preferred design of the fourth guide ensures that the wall of the brewing chamber and housing element are fixedly secured axially. The fact that the housing element and the wall of the brewing chamber are fixedly secured axially ensures that none of the guides can be touched by the user of the powder holder in the case of a closed design of the inside of the wall of the brewing chamber and the outside of the housing element in combination with the bottom of the brewing chamber, which is in sealing contact with the wall of the brewing chamber. This not only protects the user from pinching, but also the guides themselves from damage by the user or contamination, thereby contributing to improved durability. Nevertheless, the rotation of the housing element according to the invention is still possible.

In a preferred further development of the first guide, the first guide is formed as a first rail adapted to the first guide track and at least four first support profiles adapted to the first rail, wherein preferably the first rail is arranged at the guide element and two of the four first support profiles are each arranged at the bottom of the brewing chamber and two of the four first support profiles are each arranged on the wall of the brewing chamber. The arrangement of the first rail on the guide element and the arrangement of the first support profiles on the wall of the brewing chamber and the bottom of the brewing chamber allow simultaneous guidance of the bottom of the brewing chamber and the wall of the brewing chamber. The fact that two of the first support profiles are each arranged on the wall of the brewing chamber and the bottom of the brewing chamber prevents tilting and wedging of the wall of the brewing chamber and the bottom of the brewing chamber encouraged by tilting. The first support profiles adapted to the first rail ensure safe guidance.

It is advantageous that the first support profile is a circular cylinder or an elliptical cylinder, in particular a straight circular cylinder or a straight elliptical cylinder. Basically, the design of the first support profile is arbitrary, whereas a support profile, which is a circular cylinder or an elliptical cylinder, is easy to manufacture in terms of production technology and has the advantage that jamming and/or wedging is also unlikely in the first guide, including in the event of a change of direction caused by the first flanks. This also minimizes the contact surface and thus the frictional resistance. A circular cylinder is a body with two circles, which are congruent and parallel in relation to each other, as bottom and top surfaces, which are connected by a lateral surface and are formed by extrusion of the circle along a straight line. If the centers of the circular surfaces of the cylinder are on top of each other and perpendicular, it is a straight circular cylinder. An elliptical cylinder has ellipses instead of circles. These ellipses are oriented the same way.

It is also advantageous if the first support profiles are offset by the present angle of the first flank. As a result, it is possible to simultaneously slide up or down two or more first flanks at the same time. This leads to a symmetrical distribution of forces and thus to particularly efficient and smooth guidance of the first support profiles on in the first rail. This advantage is further enhanced if the first support profiles arranged on the wall of the brewing chamber and the first support profiles arranged at the bottom of the brewing chamber are arranged alternately.

In an advantageous design of the second guide, it is preferred that the second guide be formed as at least one second rail oriented in the axial direction and at least one second support profile adapted to the second rail, with the second rail preferably being formed on the guide element and the second support profile being formed on the housing element. The second guide is particularly preferably formed as two second rails oriented in the axial direction and two second support profiles adapted to the second rails. As described elsewhere, the adaptation of support profiles to rails and the arrangement of several, in particular symmetrically distributed rails and support profiles, in this case the second rail and the second support profile, ensure a very smooth-running design that is particularly secure against wedging.

In an advantageous design of the third guide, it is preferred that the third guide be formed as at least one third rail oriented in the axial direction and at least one third support profile adapted to the third rail, the rail preferably being formed on the wall of the brewing chamber and the support profile at the bottom of the brewing chamber. The third guide is particularly preferably formed as two third rails oriented in the axial direction and two third support profiles adapted to the third rails. As described elsewhere, the adaptation of support profiles to rails and the arrangement of several, in particular symmetrically distributed rails and support profiles, in this case the third rail and the third support profile, result in a very smooth-running design that is particularly secure against wedging.

In an advantageous design of the fourth guide, it is preferred that the fourth guide be formed by a groove-shaped fourth rail closed in the circumferential direction and with at least two fourth support profiles adapted to the fourth rail, the fourth support profiles preferably being arranged at the housing element and the fourth rail on the wall of the brewing chamber. The closure of the fourth rail in the circumferential direction allows the user to rotate the housing element in a complete circle, whereby there is no longer a wrong or correct direction of rotation. This prevents incorrect operation of the powder holder by the user. As described elsewhere, the adaptation of support profiles to the rail and the arrangement of several, in particular symmetrically distributed support profiles, in this case the fourth rail and the fourth support profiles, results in a very smooth-running design, which is particularly secure against wedging. In a further and preferred design of the powder holder, the guide element comprises a first body forming the conversion sleeve and a second annular body, wherein the first guide and the second guide are arranged at the first body, wherein the third guide is designed in such a way that the third guide guides the second body of the guide element in addition to the bottom of the brewing chamber and the wall of the brewing chamber and that a fifth guide is formed between the housing element and the second body, wherein the fifth guide is formed as a second guide track that is closed in the circumferential direction and preferably crown-shaped, with alternately arranged second flanks inclined in the axial direction, so that displacement of the second body and the housing element in the axial direction and the circumferential direction is simultaneously possible. The design of the guide element with two bodies makes it possible to slide the individual components of the powder holder further into each other in the manner of a telescopic rod. As a result, the installation space of the powder holder is reduced even further. The second body makes it possible to shorten the support profiles of the bottom of the brewing chamber, as part of the third guide together with the second body is raised by the fifth guide. Alternatively, it is conceivable to use the design of the guide element with the first body and the second body to bring about a third axial adjustment, which is also additive to the axial adjustments according to the invention. As the total axial adjustment to be overcome is determined by the height of the wall of the brewing chamber, the individual axial adjustments can be smaller in the case of a three-part division compared to a two-part division, thereby reducing the installation space of the parts involved, including the bottom of the brewing chamber. The installation space of the housing element, which is arranged below the brewing chamber and which receives the bottom of the brewing chamber at least partially and the guide element completely when the bottom of the brewing chamber is in the lowest position, can be made more compact and flatter in both ways.

It is further preferred that at least two of the first and/or second flanks, preferably all of the first and/or second flanks, have the same pitch. Basically, the pitch of the individual first and/or second flanks is arbitrary, but if at least two first and/or second flanks have the same pitch, the ratio of the angle of rotation of the rotational motion of the housing element to the axial adjustment of the bottom of the brewing chamber is identical when the bottom of the brewing chamber and/or the wall of the brewing chamber slide up or down the first flanks or the second body slides up or down the second flanks. By contrast, different pitches allow the user to move the bottom of the brewing chamber in the axial direction at different speeds in relation to the angle of rotation. Preferably, all first flanks have an identical first pitch and all second flanks have an identical second pitch, so that the relationship between the angle of rotation of the housing element and the movement of the bottom of the brewing chamber in the axial direction is fixed and independent of the direction of rotation and position of the bottom of the brewing chamber. It is not absolutely necessary for the first and second pitches to be identical. This makes the behavior of the powder holder predictable for the user.

In a preferred further design of the invention, it is conceivable that a plateau section be arranged between the first and/or second flanks, with the plateau section extending in the circumferential direction, in particular perpendicular to the axial direction. The arrangement of plateau sections between the first and/or second flanks ensures that a rotation of the housing element over a short distance causes no or only a slight axial movement of the bottom of the brewing chamber. In this way, the powder holder has a small amount of play in the ejection position and in the brewing position. The user then no longer has to adjust the ejection position and the brewing position of the powder holder at exactly the right moment and, instead, the powder holder has a tolerance to the rotation in the ejection position and in the brewing position. This facilitates handling.

It is also advantageous that the first guide of the powder holder comprises two to ten first flanks and/or the fifth guide of the powder holder comprises two to ten second flanks. Particularly preferably, the first and/or fifth guide comprises an even number, preferably between 2 and 20, particularly preferably between 6 and 18, of first or second flanks. Most preferably, the number of first and second flanks is identical. It is obvious to the person skilled in the art that the first or fifth guide must have an even number of first or second flanks in order to allow an alternating arrangement of the flanks and, at the same time, the closed design of the guides in the circumferential direction. The number of flanks determines by how many degrees the housing element must be rotated in relation to the wall of the brewing chamber in order to bring about a change from the brewing position to the ejection position or from the ejection position to the brewing position of the bottom of the brewing chamber, provided that the pitch of the flanks is the same for all flanks in terms of amount. The total circumference of 360° is divided by the number of flanks for this purpose. If, for example, the first guide comprises four first flanks with the same pitch in terms of amount, a change of position from the brewing position to the ejection position or from the ejection position to the brewing position is brought about after the housing element has been rotated by 90°.

Moreover, it is preferably conceivable that the powder holder comprise a locking element and a locking contour, one of which is arranged at the housing element and one on the wall of the brewing chamber in each case, and the locking contour is oriented and designed in the circumferential direction in such a way that the housing element locks against the wall of the brewing chamber in the case of at least one specified position, preferably whenever the top position and the bottom position of the bottom of the brewing chamber are reached in each case. The locking stabilizes the bottom of the brewing chamber in the specified position. For another rotation of the housing element, a small resistance must be overcome, which releases the latch. This makes it much easier to set the specified position, preferably the ejection position and the brewing position. Removal of used beverage substrate while the bottom of the brewing chamber is in the ejection position or filling in new beverage substrate while the bottom of the brewing chamber is in the brewing position is simplified, since accidental unscrewing of the powder holder from the ejection position or from the brewing position is prevented. Another preferred position for the specified position is a half position and/or an intermediate position, in which the bottom of the brewing chamber is at half the height and/or at an intermediate height between the top position and the bottom position. In the half position and/or the intermediate position, it is possible to produce only half and/or a partial quantity of the usual beverage quantity if desired. Moreover, it is conceivable and advantageous if the locking action occurs in a plurality of preferred positions, each offset from the other by a small angle. The locking action then serves as haptic feedback for the user of the powder holder.

In an advantageous further development, it is conceivable that the wall of the brewing chamber comprise at least one handle that is fixedly secured such that it is immovable in relation to the wall of the brewing chamber or at least one handle contour that is fixedly secured such that it is immovable in relation to the wall of the brewing chamber. Rotation of the housing element in relation to the wall of the brewing chamber and, consequently, the displacement of the bottom of the brewing chamber in the axial direction according to the invention is simplified by means of this handle or the handle contour. Further, the powder holder can be quickly and easily removed from the beverage preparation device or inserted into the beverage preparation device with the aid of the handle or the handle contour. Moreover, it simplifies localization of the powder holder in the beverage preparation device for the user. The design of the handle is arbitrary, with the handle preferably designed as a stem. The handle contour can be formed integrally with a part of the wall of the brewing chamber or fixedly secured to the wall of the brewing chamber as a separate component. A wing is a particularly preferred design of a handle contour.

Preferably, the wall of the brewing chamber and the housing element each have a regular, non-circular surface profile, wherein the surface profile of the wall of the brewing chamber and the surface profile of the housing element are congruent at the top and bottom positions of the bottom of the brewing chamber. The surface profile of the wall of the brewing chamber and the surface profile of the housing element extend in a plane perpendicular to the axial direction of the powder holder. The congruent arrangement of the surface profiles provides the user with feedback that the top position, the ejection position and the bottom position, the brewing position, represent a particular position of the bottom of the brewing chamber. Further, it is possible to design the structure in which the powder holder is placed in the beverage preparation device in such a way that the powder holder can only be inserted into this structure if the surface profiles are congruent. In other words, the powder holder can only be inserted into the beverage preparation device when the bottom of the brewing chamber is in the ejection or brewing positions. This reduces the likelihood of incorrect operation of the beverage preparation device. Alternatively, it is advantageously conceivable that the congruent arrangement only be present in the brewing position of the bottom of the brewing chamber. In this way, incorrect operation such as inserting the powder holder in a position other than the brewing position is impossible if the structure for holding the powder holder is designed accordingly. A regular surface profile is understood to be a figure that merges into itself when rotated by a certain angle and is therefore rotationally symmetrical. Basically, a circle is also rotationally symmetrical, but the desired feedback is not possible with a circle, since a circle merges into itself regardless of the degree of rotation and the surface profiles would always be congruent in the present case. The surface profiles are congruent when prominent structures of the surface profiles are aligned with each other. For example, the wall of the surface profile of the wall of the brewing chamber and the surface profile of the housing element are designed as a regular polygon, with the corners of the regular polygon representing the prominent structures. The surface profile of the wall of the brewing chamber and the surface profile of the housing element are therefore congruent when the corners of the polygons are lying on top of each other. The surface profiles may deviate from each other for reasons of manufacturing technology and design. The exact design of the surface profile is also basically arbitrary. However, the angle of rotation by which the surface profile is to be rotated in order to merge into itself depends on the number of first flanks in the corresponding design. This is due to the relationship between the angle of rotation of the powder holder and the number of first flanks, as explained elsewhere. The angle of rotation is obtained by dividing 360° by the number of first flanks if the congruent arrangement in the brewing and ejection positions is to be brought about. If the congruent arrangement is only desired in the brewing position, the angle of rotation must be doubled subsequently. Preferably, the surface profile of the brewing chamber and the surface profile of the housing element comprise a regular polygon, even more preferably a regular polygon with rounded corners, while a square with rounded corners corresponding to a design of the first guide with four flanks is most preferred. The surface profile is also preferably a circle flattened at two opposite points. Such a circle can be formed, for example, by a circle that is intersected by two parallel chords that lie opposite each other at the same distance from the center of the circle. In this preferred embodiment, if the first guide also has four flanks and if the surface profile of the wall of the brewing chamber and the surface profile of the housing element are congruent in the brewing position of the bottom of the brewing chamber and if the structure for reception of the powder holder in the beverage preparation device has rails spaced in accordance with the distance between the chords, the powder holder can only be inserted when the bottom of the brewing chamber is in the brewing position and cannot be inserted in any other position.

In a further design, it is preferred that the guide element or the first body have two parts, wherein the first guide, preferably the first rail, be bounded in the axial direction by a first part on one side and by a second part on the other side and the two parts are fixedly secured in relation to each other. The two-part design simplifies the manufacture and assembly of the powder holder. It is also possible to completely disassemble the powder holder, for example for repair, maintenance and/or cleaning.

In yet another advantageous embodiment of the invention, it is further conceivable that the housing element have an at least partially textured surface and/or outside. The textured surface makes it easier to grip and/or hold the housing element and gives the housing element additional stability. The textured surface is preferably closed in the circumferential direction and formed by spaced-apart rods extending in the axial direction.

It is also desirable for the housing element to have two parts and/or be formed as a hollow body. The hollow body is preferably formed by radial spacing of a first wall from a second wall of the housing element, with the first wall forming the side facing the wall of the brewing chamber and the second wall forming the outside. In the context of the invention, it has been recognized that a hollow body is a poor conductor of heat. Therefore, the heat of the hot brewing fluid, which is conducted through the brewing chamber during the brewing operation, is not transmitted to the outside of the housing element, or only to a small extent, and the user is protected from burns and/or scalding. It is also conceivable that the hollow body be filled with additional heat-insulating materials in order to further increase the protective effect. The two-part design simplifies the manufacture and assembly of the housing element. The housing element can also be completely disassembled, for example for repair, maintenance and/or cleaning.

In yet another preferred further design of the invention, it is conceivable that the guide element be arranged in the axial direction below the bottom of the brewing chamber. In the context of the invention, it has been recognized that the bottom of the brewing chamber can be in sealing contact with the wall of the brewing chamber when the guide element is arranged in the axial direction below the bottom of the brewing chamber. At the same time, the wall of the brewing chamber can be kept free of guides in which the beverage substrate can accumulate, thereby promoting the formation of germs. Furthermore, the guide element should be enclosed by the housing element as completely as possible, and the powder holder should have a construction that is as compact and stable as possible. The arrangement of the guide element in the axial direction below the bottom of the brewing chamber therefore allows the smooth design of the wall of the brewing chamber with a design that is simultaneously as compact as possible.

In yet another advantageous further design of the invention, it is conceivable that the housing element comprise a receiving shaft arranged above an outlet opening at the bottom end for receiving the wall of the brewing chamber, the bottom of the brewing chamber and the guide element. In this way, the wall of the brewing chamber, the bottom of the brewing chamber and the guide element can be integrated into the housing element and protected from damage by contact, for example. The beverage fluid can escape unhindered from the powder holder through the outlet opening at the bottom end.

It is assumed that the definitions and explanations of the above-named terms apply to all aspects described below in this description, unless otherwise stated.

According to the invention, a beverage preparation device comprising the powder holder according to the invention is further proposed.

### BRIEF DESCRIPTION OF THE DRAWINGS

Further details, features and advantages of the invention result from the following description of the preferred embodiments in conjunction with the subclaims. The respective features can be realized individually or in combination with each other. The invention is not limited to the embodiments. The embodiments are shown schematically in the figures. Identical reference numerals in the individual figures designate identical or functionally identical elements or elements that correspond to each other in terms of their function.

The following details are shown:

FIG. 1 An exploded view of a first version of a powder holder according to the invention,

FIG. 2A to 2C A sequence of movements resulting from the rotation of the first embodiment of a powder holder according to the invention and

FIG. 3A to 3B A sequence of movements that occurs when a second version of a powder holder according to the invention is rotated.

### DETAILED DESCRIPTION

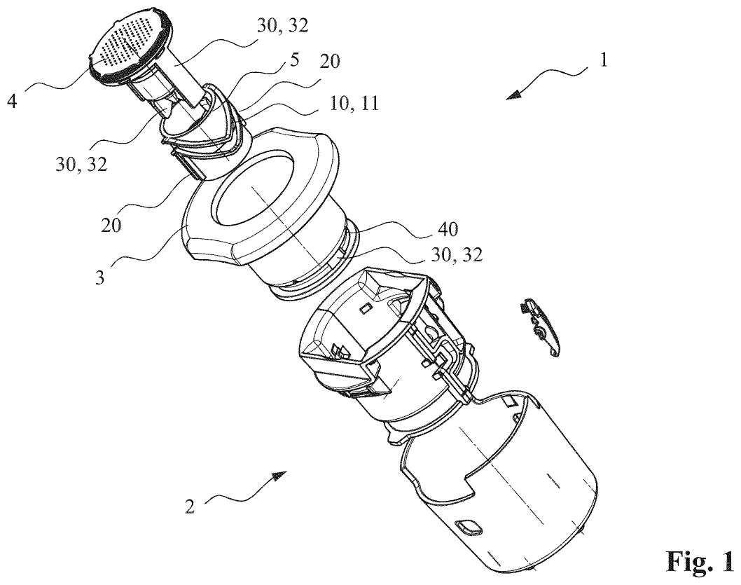

FIG. 1 shows an exploded view of a powder holder 1 according to the invention. The powder holder 1 comprises a housing element 2, a brewing chamber wall 3, an axially adjustable brewing chamber bottom 4 and a guide element 5.

The housing element 2 has three parts, with two parts forming the inside and the third part being slipped over the inside to form the outside. This creates a hollow space between the inside and outside of the housing element 2, so that the housing element 2 is a hollow body. The hollow space has an insulating effect, so that only a small amount of heat from the brewing fluid penetrates from the inside wall of the brewing chamber wall 3 to the outside of the housing element 3 via the housing element 2.

The brewing chamber wall 3 forms a hollow cylinder and is designed with a smooth surface. The brewing chamber wall 3 is arranged on the inside of the housing element 2.

The brewing chamber bottom 4 is also arranged inside the housing element 2 and at least partially inside the brewing chamber wall 3. The brewing chamber bottom 4 has a filter means on its upper side. The brewing chamber wall 3 and the brewing chamber bottom 4 form a brewing chamber in which the beverage substrate is placed.

The guide element 5 is arranged below the filter means of the brewing chamber bottom 4. The guide element 5 is designed as a sleeve and serves to convert axial adjustments of the brewing chamber bottom 4 in relation to the brewing chamber wall 3. In order to allow this conversion, a first guide 10 is formed between the guide element 5 and the brewing chamber wall 3 as well as the guide element 5 and the brewing chamber bottom 4. The first guide 10 comprises a first rail 11 arranged on the outside of the guide element 5, which has four first flanks. Two of the four first flanks are clearly visible in FIG. 1. Two first support profiles 12, not shown in FIG. 1, which are arranged on the brewing chamber wall 3 and the bottom of the brewing chamber 4, are each guided in the first rail 11.

A transmission of a rotation of the housing element 2 to the guide element 5 must be allowed in order for the brewing chamber wall 3 and the brewing chamber bottom 4 to be able to slide along the first flanks of the first guide 10 in the case of the first embodiment. At the same time, the guide element 5 must be adjustable in the axial direction in relation to the housing element 2 and, as explained later, also in relation to the brewing chamber wall 3 and the brewing chamber bottom 4 in order to allow the conversion. This is made possible by a second guide 20. The second guide 20 has two second rails that are oriented in the axial direction and arranged at the guide element 5. Two support profiles arranged at the housing element 2, which are not visible in FIG. 1, are guided in the second rails.

A third guide 30 is provided between the brewing chamber wall 3 and the brewing chamber bottom 4 so that the brewing chamber bottom 4 is adjustable in the axial direction in relation to the brewing chamber wall 3 in accordance with the invention. The third guide 30 comprises two third rails 31 oriented in the axial direction, which are arranged on the underside of the brewing chamber wall 3, wherein only one of the two third rails 31 is visible in FIG. 1. The brewing chamber bottom 4 has two third support profiles 32 of the third guide 30 that are adapted to the short third rails 31. The third support profiles 32 are elongated and arranged below the filter means so that they can be guided in the short third rail 31.

A fourth guide 40 is arranged between the housing element 3 and the brewing chamber wall 4 in order to allow the housing element 2 to rotate in relation to the brewing chamber wall 3, The fourth guide 40 comprises a fourth rail that is closed in the circumferential direction and arranged on the outside of the brewing chamber wall 3 and in which two fourth support profiles not shown in FIG. 1 are guided. The support profiles are arranged on the inside of the housing element 2.

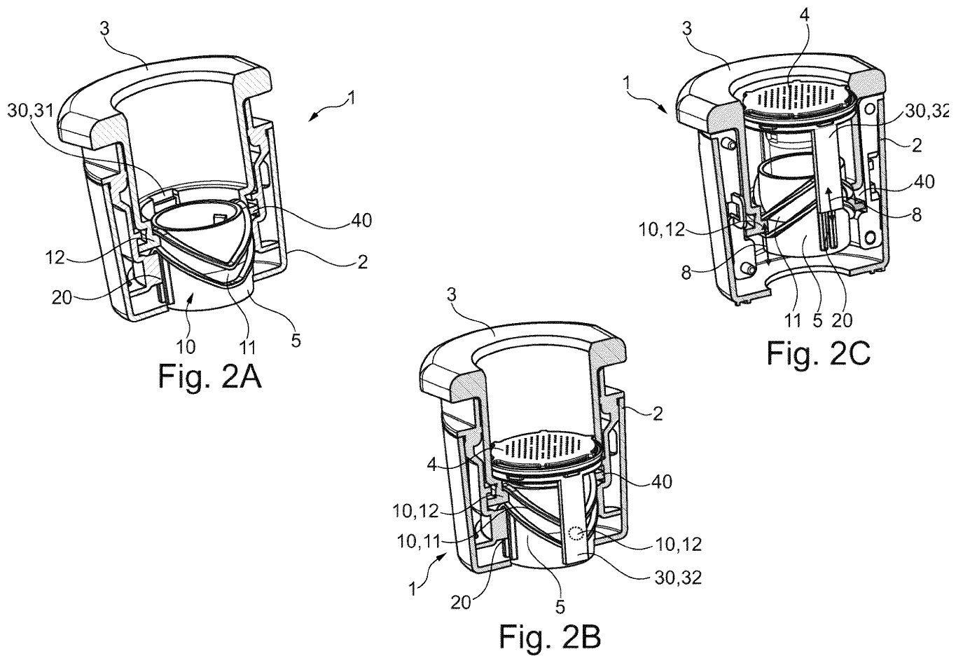

FIGS. 2A to 2B show a sequence of movements that occurs when the first embodiment of a powder holder 1 according to the invention shown in FIG. 1 is rotated. FIG. 2A shows the first embodiment of the powder holder 1 without the brewing chamber bottom 4. As a result, one of the two third rails 31 of the third guide 30 is clearly visible on the inside of the brewing chamber wall 3. The brewing chamber wall 3 is fixedly secured in relation to the housing element 2 by the fourth guide 40. One of the two fourth support profiles, which are arranged at the housing element 2, is shown in the fourth rail, which is arranged on the brewing chamber wall 3, to form the fourth guide 40 in FIG. 2A. The guide element 5 has the first rail 11 of the first guide 10, wherein the first support profiles 12 are guided in the first rail 11.

FIG. 2B shows the same situation as FIG. 2A, wherein the brewing chamber bottom 4 has been inserted into the powder holder 1. The brewing chamber bottom 4 has the third support profiles 32 of the third guide 30, which extend on the underside of the brewing chamber bottom 4. Two more first support profiles 12 belonging to the first guide 10 are arranged at the third support profiles 32, which are concealed by the third support profiles 32. Therefore, the first support profile 12, which is arranged at the third support profile 32 of the brewing chamber bottom 4 that is visible in FIG. 2B, is indicated by a dotted line. The first support profiles 12 arranged on the brewing chamber wall 3 and the first support profiles 12 arranged at the brewing chamber bottom 4 are each offset by the present angle of one of the first flanks of the first guide 10 and arranged alternately. In the first embodiment, this angle corresponds to 90°. In FIG. 2B, the brewing chamber bottom 4 is in the bottom position, which is also referred to as the brewing position. It is clearly visible that there is a space between the wall of the brewing chamber 2 and the bottom of the brewing chamber 3, which forms the brewing chamber.

In FIG. 2C, the housing element 2 has been rotated by 90° in relation to the brewing chamber wall 2 and the brewing chamber bottom 3 in FIG. 2B. It is clearly visible that the guide element 5 has been raised by an axial adjustment 8 in relation to the brewing chamber wall 2. The axial adjustment 8 was caused by the fact that the first support profiles 12 arranged on the brewing chamber wall 2 have slid down on the first flanks and are now arranged at the low points of the first guide 10. This has occurred because the rotation of the housing element 2 was transmitted to the guide element 5 by the second guide 20 and the guide element 5 has therefore also rotated by 90° in relation to the brewing chamber wall 3. At the same time, the brewing chamber bottom 4 has also been raised in relation to the guide element 5 by the axial adjustment 8. This is due to the fact that the first support profiles 12 arranged at the brewing chamber bottom 4 have slid up on the first flanks of the first rail 11, which is also due to the rotation of the guide element 5 together with the housing element 2. The third guide 30 holds the brewing chamber bottom 4 and the brewing chamber wall 3 in place in the circumferential direction. Both axial adjustments 8, that of the guide element 5 in relation to the brewing chamber wall 3 and that of the brewing chamber bottom 4 in relation to the guide element 5, take place in the same direction and therefore have an additive effect. The brewing chamber bottom 4 is therefore raised to a top position, which is the ejection position. In this position of the brewing chamber bottom 4, used beverage substrate can be removed easily and completely, since the brewing chamber bottom 4 is flush with the wall of the brewing chamber 2.

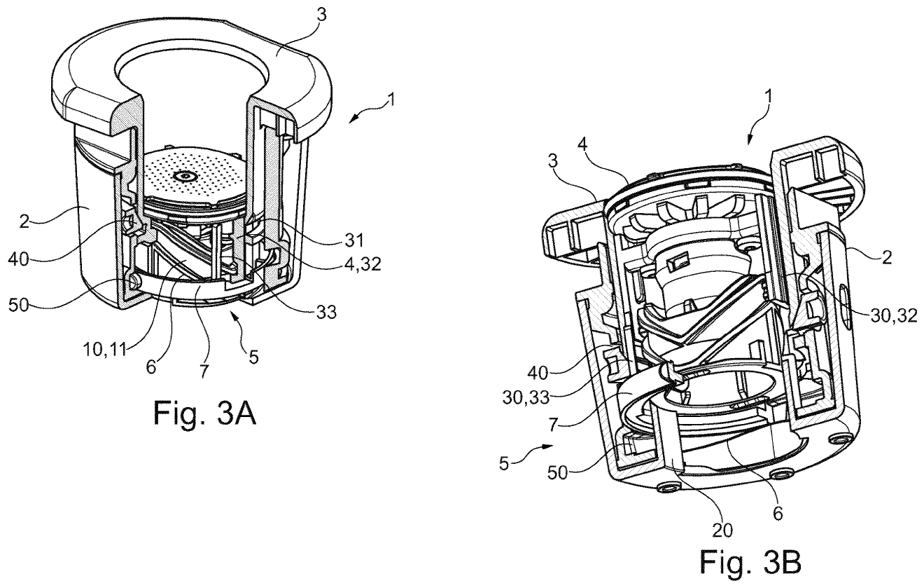

FIGS. 3A to 3B show a sequence of movements resulting from the rotation of a second version of a powder holder 1 according to the invention. The powder holder 1 also comprises a housing element 2, a brewing chamber wall 3, a brewing chamber bottom 4 and a guide element 5. As in the first embodiment, the brewing chamber wall 2 and the brewing chamber bottom 3 form a brewing chamber. The guide element 5 comprises a first body 6, wherein the first body 6 is designed as a conversion sleeve. The guide element 6 additionally comprises a second body 7 designed as a ring. The second body 7 is arranged around the first body 6 in the circumferential direction and at a distance from it. A first rail 11 of a first guide 10 is formed on the first body 6, wherein two first support profiles 12, which are each arranged on the brewing chamber wall 3 and at the brewing chamber bottom 4, are each guided in the first rail 10. The first guide 10 of the second embodiment is identical to the first guide 10 of the first embodiment in terms of design and function (FIG. 1 and FIGS. 2A to 2C). A second guide 20 is arranged between the first body 6 and the housing element 2 in such a way that a rotation of the housing element 2 in relation to the brewing chamber wall 2 and the brewing chamber bottom 3 is transmitted to the first body 6. However, the first body 6 can move in the axial direction in relation to the housing element 2.

Further, a third guide 30 is formed between the brewing chamber wall 2, the brewing chamber bottom 3 and the second body 7. The third guide 30 determines the brewing chamber wall 3, the brewing chamber bottom 4 and the second body 7 in the circumferential direction in relation to each other. However, displacement of the brewing chamber wall 3, the brewing chamber bottom 4 and the second body 7 in the axial direction in relation to each other is still possible. The brewing chamber bottom 4 is guided by means of two elongated third support profiles 32 within two conversion profiles 33, which are designed both as a rail and as a support profile and arranged at the second body 7. The conversion profiles 33 are guided in a third rail 31, which is arranged on the brewing chamber wall 3. In direct comparison, the third support profiles 32 in the second embodiment are shorter than in the first embodiment, whereby the powder holder 1 of the second embodiment can be flatter overall.

A fourth guide 40 identical to the first embodiment (FIG. 1 and FIGS. 2A to 2C) is arranged between the brewing chamber wall 3 and the housing element 2 in order to allow the housing element 2 to rotate in relation to the brewing chamber wall 3. A fifth guide 50 is arranged between the second body 7 and the housing element 2. The fifth guide 50 comprises a fifth rail with second flanks that are designed in the same manner as the first guide 10 and arranged at the housing element 2. Fifth support profiles of the fifth guide 50 arranged at the second body 7 are guided in the fifth rail. When the fifth support profiles slide up or down the second flanks due to a rotation of the housing element 2 in relation to the second body 7, the second body 7 is displaced in the axial direction in relation to the housing element 2.

In FIG. 3A, the brewing chamber bottom 4 is in the lowest position. If the housing element 2 is now rotated by 90° in relation to the brewing chamber wall 3, the rotation is simultaneously transmitted to the first body 6 via the second guide 20. At the same time, the first body 6 and the brewing chamber bottom 4 are fixedly secured in the circumferential direction with the brewing chamber wall 3 by the third guide 30. This means that the first body 6 is also twisted in relation to the brewing chamber wall 3 and the brewing chamber bottom 4. The first support profiles 12 therefore slide along the flanks of the first rail 11. The brewing chamber wall 3 is fixedly secured in the axial direction in relation to the housing element 2 by the fourth guide 40, so that the first body 6 undergoes an upward axial adjustment in relation to the brewing chamber wall 3 as a result of the first support profiles 12 sliding on the first flanks. At the same time, the brewing chamber bottom 4 also undergoes an axial adjustment in an upward direction in relation to the first body 6, since the first support profiles 12 arranged at the brewing chamber bottom 4 also slide along the first flanks. The two axial adjustments are additive, so that the brewing chamber bottom 4 is raised to the top position, which is shown in FIG. 3B. However, FIG. 3B also shows that, due to the shortened design of the third support profiles 32, these would jump out of the rails of the conversion profile 33 arranged at the second body 7 if the second body 7 did not also undergo axial adjustment. The axial adjustment of the second body 7 is caused by the rotation of the second body 7 in relation to the housing element, which is transmitted to the second body 7 by the third guide 30. The fifth support profiles arranged at the second body 7 slide along the second flanks of the fifth rail and in this way cause the necessary axial adjustment of the second body 7.

### List of Reference Symbols

1 Powder holder
2 Housing element
3 Brewing chamber wall
4 Brewing chamber bottom
5 Guide element
6 First body
7 Second body
8 Axial adjustment
10 First guide
11 First rail
12 First support profile
20 Second guide
30 Third guide
31 Third rail
32 Third support profile
33 Conversion profile
40 Fourth guide
50 Fifth guide

1. A powder holder (1) to be removably received in a beverage preparation device, wherein the powder holder (1) comprises a housing element (2), a brewing chamber wall (3), a guide element (5) and a brewing chamber bottom (4) movably mounted in the axial direction, wherein the brewing chamber bottom (4) is in sealing contact with the brewing chamber wall (3) and is formed with filter means for retaining a beverage substrate during a brewing process,
wherein
the guide element (5) is formed as a conversion sleeve and a first guide (10) is arranged on the guide element (5), wherein the brewing chamber bottom (4) and the brewing chamber wall (3) are guided in the first guide and
wherein the guide element (5) and the first guide (10) are designed such that a rotation of the housing element (2) in relation to the brewing chamber wall (3) causes axial displacement (8) of the guide element (5) in relation to the brewing chamber wall (3) and axial displacement (8) of the brewing chamber bottom (4) in relation to the guide element (5), so that two-stage additive axial displacement (8) of the brewing chamber bottom (4) in relation to the brewing chamber wall (3) takes place between a top position and a bottom position.

2. The powder holder according to claim 1,
wherein
the first guide (10) is formed by a first guide track that is closed in the circumferential direction and crown-shaped, with alternately arranged first flanks inclined in the axial direction, so that displacement of the guide element (5) and the brewing chamber bottom (4) and of the guide element (5) and the brewing chamber wall (3) is allowed simultaneously in the axial direction and in the circumferential direction;
a second guide (20) is formed between the housing element (2) and the guide element (5), wherein the second guide (20) is formed to allow displacement of the housing element (2) and the guide element (5) in the axial direction,
a third guide (30) is formed between the brewing chamber bottom (4) and the brewing chamber wall (3), wherein the third guide (30) is formed to allow displacement of the brewing chamber wall (3) and the brewing chamber bottom (4) or displacement of the guide element (5) and the brewing chamber bottom (4) in the axial direction and/or a fourth guide (40) is formed between the housing element (2) and the brewing chamber wall (3), wherein the fourth guide (40) is formed to allow the rotation between the housing element (2) and the brewing chamber wall (3), in the circumferential direction.

3. The powder holder according to claim 2,
wherein
the first guide (10) is formed as a first rail (11) adapted to the first guide track and at least four first support profiles (12) adapted to the first rail (11), wherein preferably the first rail (11) is arranged on the guide element (5) and two of the four first support profiles (12) are each arranged on the brewing chamber bottom (4) and two of the four first support profiles (12) are each arranged on the brewing chamber wall (3).

4. The powder holder according to claim 3,
wherein
the first support profile (12) is a circular cylinder or an elliptical cylinder.

5. The powder holder according to claim 3,
wherein
the first support profiles (12) are arranged such that they are offset by the angle of one flank.

6. The powder holder according to any claims 2,
wherein
the second guide (20) is designed as at least one second rail oriented in the axial direction and at least one second support profile adapted to the second rail, wherein the second rail is formed on the guide element (5) and the second support profile is formed on the housing element (2).

7. The powder holder according to claims 2,
wherein
the third guide (30) is designed as at least one third rail (31) oriented in the axial direction and at least one third support profile (32) adapted to the third rail (31), wherein the third rail (31) is formed on the brewing chamber wall (3) and the third support profile (32) is formed on the brewing chamber bottom (4).

8. The powder holder according to claim 2,
wherein
the fourth guide (40) is formed by a groove-shaped fourth rail that is closed in the circumferential direction and with at least two fourth support profiles adapted to the fourth rail, wherein the fourth support profiles are arranged on the housing element (2) and the fourth rail is arranged on the brewing chamber wall (3).

9. The powder holder according to claim 2,
wherein
the guide element (5) comprises a first body (6) forming the conversion sleeve and a second annular body (7),
wherein the first guide (10) and the second guide (20) are arranged on the first body (6),
wherein the third guide (30) is designed in such a way that the third guide (30) guides the second body (7) of the guide element (5) in addition to the brewing chamber bottom (4) and the brewing chamber wall (3) and a fifth guide (50) is formed between the housing element (2) and the second body (7), wherein the fifth guide (50) is formed as a second crown-shaped guide track that is closed in the circumferential direction, with alternately arranged second flanks inclined in the axial direction, to allow displacement of the second body (7) and housing element (2) simultaneously in the axial direction and in the circumferential direction.

10. The powder holder according to claims 2,
wherein
at least two of the first and/or second flanks have the same pitch.

11. The powder holder according to claims 2,
wherein
a plateau section is arranged between the first and/or second flanks, wherein the plateau section extends in the circumferential direction perpendicular to the axial direction.

12. The powder holder according to claim 2,
wherein
the first guide (10) and/or the fifth guide (50) comprise(s) two to ten flanks.

13. The powder holder according to claim 1,
further comprising
a locking element and a locking contour, one of which is arranged on the housing element (2) and one on the brewing chamber wall (3) and the locking contour is oriented and formed in the circumferential order such that the housing element (2) locks in relation in relation to the brewing chamber wall (3) in at least one specified position, when the top and bottom positions of the brewing chamber bottom (4) are reached.

14. The powder holder according to claim 1,
wherein
the brewing chamber wall (3) comprises at least one handle fixedly secured to be immovable in relation to the brewing chamber wall (3) or at least one handle contour fixedly secured to be immovable in relation to the brewing chamber wall (3).

15. The powder holder according to claim 1,
wherein
the brewing chamber wall (3) and the housing element (2) each have a regular, non-circular surface profile, wherein the wall of the brewing chamber surface profile and the housing element surface profile are congruent in the top and bottom positions of the brewing chamber bottom (4).

16. The powder holder according to claim 15,
wherein
the surface profile is a rounded square or a circle flattened at two opposite points.

17. The powder holder according to claim 1,
wherein
the guide element (5) or the first body (6) has two parts, wherein the first guide (10) is bounded in the axial direction by a first part on one side and by a second part on the other side and the two parts are fixedly secured in relation to each other.

18. The powder holder according to claim 1,
wherein
the housing element (2) has an at least partially structured surface and/or outside.

19. The powder holder according to claim 1,
wherein
the housing element (2) is formed with multiple parts and/or as a hollow body

20. The powder holder according to claim 1,
wherein
the guide element (5) is arranged below the brewing chamber bottom (4) in the axial direction.

21. The powder holder according to claim 1,
wherein
the housing element (2) comprises a receiving shaft that is arranged above an outlet opening at the bottom end and serves to receive the brewing chamber wall (3), the brewing chamber bottom (4) and the guide element (5).

22. A beverage preparation device comprising a powder holder (1) according to claims 1.
